(19) United States
(12) Patent Application Publication
(10) Pub. No.: US 2012/0239470 A1
(43) Pub. Date: Sep. 20, 2012

(54) Advertising Element Attachable to Product

(76) Inventor: Tim Goldburt, New York, NY (US)

(21) Appl. No.: 13/486,114

(22) Filed: Jun. 1, 2012

Related U.S. Application Data
(63) Continuation-in-part of application No. 11/588,494, filed on Oct. 28, 2006.

(51) Int. Cl. G06Q 30/02

(52) U.S. Cl. 705/14.4

(57) ABSTRACT

An advertising element attachable to a product has a body attachable to a product for example by snapping in or in a different way, a display for displaying advertising information, an electronic unit operative for displaying the advertising information on the display, an audio unit for producing audio messages, and components for displaying preliminarily stored video messages and user-introduced video messages.

### CROSS REFERENCE TO RELATED APPLICATIONS

This application is a continuation-in-part of patent application Ser. No. 11/588,494 filed Oct. 28, 2006.

Some subject matter of the present application can be also found in patent application Ser. Nos. 11/821,335 filed on Jun. 22, 2007; 11/821,334 filed on Jun. 22, 2007; 11/821,349 filed Jun. 22, 2007; 12/454,862 filed May 27, 2009; 12/454,863 filed 0/27/2009; 12/590,000 filed Nov. 2, 2009; 12/590,013 filed May 5, 2009; 12/655,442 filed Dec. 29, 2009; 12/655,418 filed Dec. 29, 2009; 12/655,444 filed Dec. 29, 2009.

### BACKGROUND OF THE INVENTION

The present invention relates to advertising elements attachable to various products.

Advertising elements attachable to products are well known and widely utilized in commerce. The advertising elements usually contain a name of product, its components, place of origin, its ingredients, number of calories, etc. The known advertising elements are usually composed of paper, plastic, metal etc., and the information provided on them, once placed there, is unchangeable. Also such information frequently is not recognizable sufficiently clear even by people with very good vision. It is therefore believed that there is a need to improve the existing advertising elements which are directly attachable to products, such as shoes, clothes, furniture, beverage containers, foods, cars, jewelry, etc, as well as their packaging, cases, enclosures etc.

### SUMMARY OF THE INVENTION

Accordingly it is on object of the present invention to provide an advertising element attachable to a product, which is an improvement of existing advertising elements.

In keeping with these objects and with others which will become apparent hereinafter, one feature of the present invention resides, briefly stated, in a body attachable to a product; a display for displaying advertising information; and electronic means operative for displaying the advertising information on the display.

In accordance with another feature of the present invention the advertising element includes a battery providing a battery-operated power operation of the electronic means and the display.

In accordance with a further feature of the present invention the advertising element includes a cable connecting the electronic means and the display to a power source.

In accordance with another feature of the present invention the electronic means of the advertising element include a microprocessor.

In accordance with a further feature of the present invention the advertising element has control means operatable by a user and acting on the electronic means for providing information desired by a user on the display.

In accordance with a further feature of the present invention the advertising element has a memory which stores an information so that the information which is stored preliminarily can be displayed on the display.

In accordance with a further feature of the present invention, the electronic means are formed and operate so that on the display a preliminarily stored information and an information introduced by a user can be displayed.

In accordance with a further feature of the present invention the advertising element has an audio message producing means, and the electronic means are arranged and operable to operate the audio message producing means.

In accordance with a further feature of the present invention, the advertising element has a contact sensor and a movement sensor operative for activating the electronic means in response to a contact with or movement in a vicinity of the advertising element correspondingly.

In accordance with another feature of the present invention the body is springy so that it can be snapped in to a cavity of the product so as to be first compressed, introduced into the cavity of the product in a compressed state, and then expand in the cavity to be held in the latter by a springy action.

In accordance with a further feature of the present invention, the advertising element has control means operatable by a user.

In accordance with a further feature of the present invention, the control means include an alpha-numerical keyboard operatable by a user.

In accordance with a further feature of the present invention the control means include a plurality of buttons including an on/off button, an entry button, an up button and a down button.

In accordance with still a further feature of the present invention a system is proposed which Includes the product provided with the advertising element, or a product packaging provided with the advertising element, or the product provided with the advertising element and located in the packaging which is also provided with the advertising element.

The novel features of the present invention will be set of in the appended claims. The Invention itself however, both as to its construction and a manner of operation, will be best understood from the description of the preferred embodiments which is accompanied by the following drawings.

### BRIEF DESCRIPTION OF THE DRAWINGS

FIG. 1 is a front view of an advertising element in accordance with the present invention:

FIG. 2 is a view showing electronic components of the advertising element in accordance with the present invention;

FIGS. 3 and 4 are views showing two variants of additional elements of the inventive advertising element; and

FIG. 5 is a view showing the inventive advertising elements attachable to a packaging of a product, or to a product, or to both.

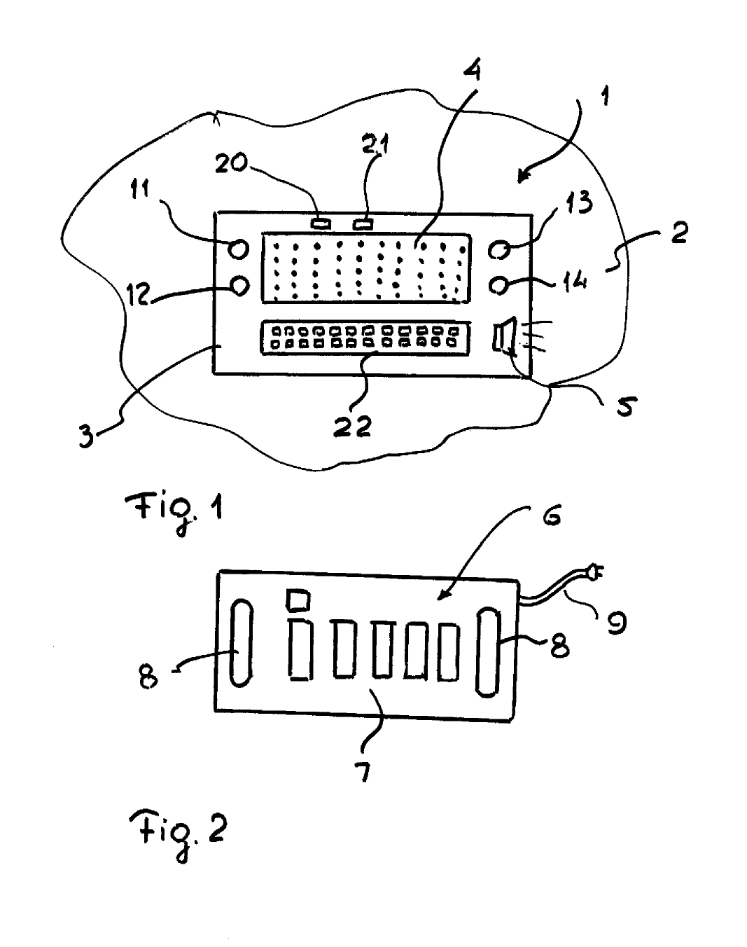

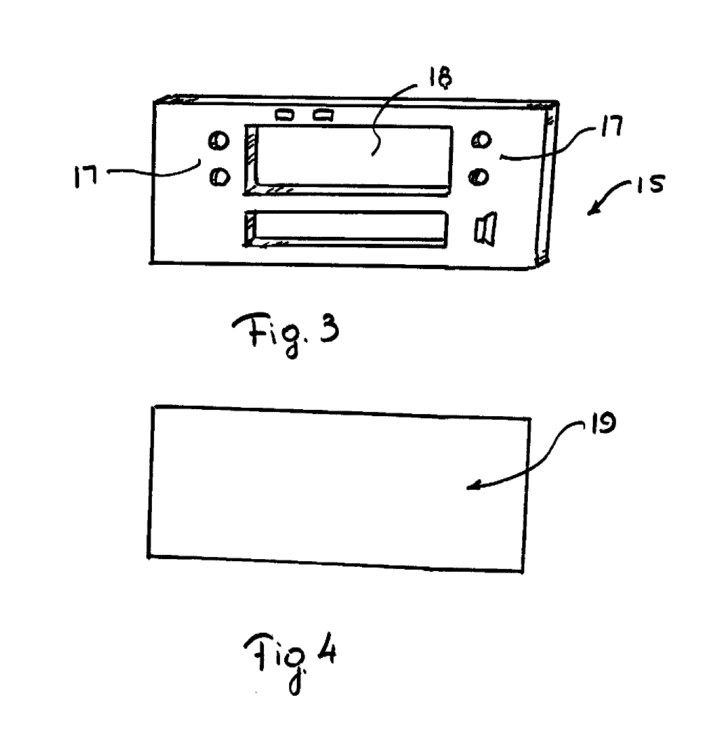

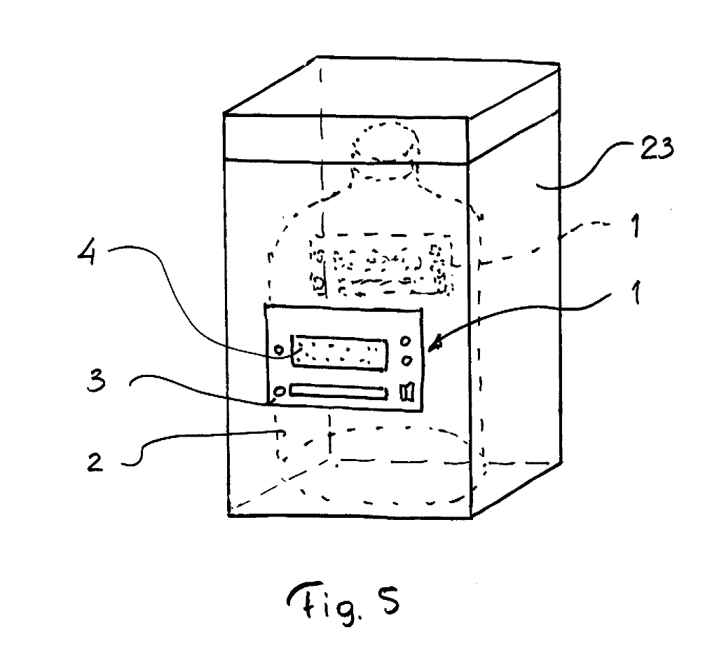

### DESCRIPTION OF THE PREFERRED EMBODIMENTS

An advertising element in accordance with the present invention is identified as a whole with reference numeral 1. The advertising element 1 is attachable to a product 2, which can be shoes, clothes, furniture, beverage containers, foods, cars, jewelry, etc., and also attachable to their packaging, cases, enclosures, containers, etc.

The advertising element 1 has a body 3 which supports and/or accommodates all other components. The advertising element 1 has a display 4 for displaying information in form of video images, such as advertising images, proprietary images, running light images, alpha-numerical images, decorative images, etc. The advertising element 1 further has audio message producing unit 5 which produce audio messages, such as words, announcements, music, etc.

The video images producing display 4 and the audio messages producing unit 5 can operate separately or jointly, so as to produce only the video images, the audio messages, and both the video images and the audio messages which can be irrelevant or relevant to each other.

The display 4 can include a plurality of LEDs or OLEDs, for example five rows and twenty five columns of these illuminating elements. The audio message producing unit can be formed as a miniature speaker/speakers.

The advertising element 1 further has electronic means 6 which include a microprocessor 7 with a memory, batteries 8 for a battery-powered operation and an electric cable 9 which is connectable to a power source for an outer-powered operation. The microprocessor stores in the memory letters, numbers, symbols, and also stores in the memory preliminarily selected stored messages.

The microprocessor has means for generating the corresponding elements (letters, numbers, symbols) and also preliminarily selected video images on the display 4. The microprocessor also has means for generating corresponding audio messages by the audio message generating means 5. The video images on the display 4 and the audio messages in the audio unit 5 can be generated separately from each other or jointly. They can be relevant or irrelevant to each other. The video images and/or audio Messages can be generally of advertising nature, but can be also in addition formed as informative, decorative, running light, and other video images, and as informative, musical and other audio messages.

The advertising element further has control means 10 operatable by a user and acting On the electronic means 6. The control means include an on/off button 11, an entry button 12, an up button 13 and a down button 14.

The advertising element can be operated in the following manner.

When a user presses the on/off button, a preliminarily stored video image is displayed on the display 4 and a preliminarily stored audio message is produced by the audio unit 5. By pushing the button 13 or the button 14 the other preliminarily provided video Images or audio messages can be selected in an ascending order or in a descending order.

A user can compose a new video images to be displayed on the display 4 or generated by the audio unit 5. For this purpose the entry button 12 is pressed, and by pressing the buttons 13 and 14 corresponding new video messages successively appear on the display 4 and new audio messages are generated by the audio unit 5. In order to memorize these video images and/or audio messages, the entry button is pressed again. By repeating this operation, a corresponding composite video images and audio messages can be composed and then memorized by pressing the on-off button. Thus the user's selection is displayed on the display 4 and emitted in the audio unit 5.

An additional element 15 can be placed onto the front surface of the of the advertising element 1, so that the protruding display 4 and the protruding buttons 12,13,14,15 can snap into openings 16 and 17 and firmly hold the additional element 15. On the other hand, a different band-like additional element 18 can be alternatively placed on the from surface of the advertising element and can be transparent.

The advertising element 1 as a whole can be springy so that it can be snapped Into a cavity 19 of the product 2 or its enclosure. The springy advertising element 1 is first compressed, then pressed, and then slightly expands and is held in the cavity by a springy action.

The advertising element can be also provided with a contact sensor 20 and/or a movement sensor 21. When the sensor 20 is touched, or there is a movement in the proximity to the sensor 21, the electronic means are activated, and the display 4 displays video images and/or the audio unit emits audio messages.

In accordance with the present invention, the control means operatable by a user can be also formed as an alpha-numerical keyboard 22.

The body of the advertising element can be attached to a product or its enclosure also in different ways, for example by gluing, bolting etc to it, or by placing on the surface or its enclosure and gluing, bolting etc of the ends of the additional element which covers the advertising element.

FIG. 5 shows the advertising element 1, the product 2 and the product package or enclosure 23. The present invention also encompasses a system which positively includes the advertising element 1 and the product 2 to which the advertising element 1 is attached. It also encompasses the system which includes the advertising element 1 and the product's enclosure or packaging 23. It also encompasses a system which includes the product 2 to which the advertising element 1 is attached, and the packaging 23 to which another advertising element 1 is attached.

While the invention is described hereinabove, it is not limited to the details shown since various modifications and structural changes are possible without departing from the spirit of the invention.

What is desired to be protected by Letters Patent is set forth in the appended claims:

1. An advertising element attachable to an object selected from the group consisting of a product, a packaging of a product, and both, the advertising element comprising a body attachable to an object, a display for displaying advertising information; and electronic means operative for displaying the advertising information on the display.

2. An advertising element as defined in claim 1, further comprising battery means for battery-operated operation of said electronic means and said display.

3. An advertising element as defined in claim 1, further comprising cable means for connecting said electronic means and said display to a power source.

4. An advertising element as defined in claim 1, wherein said electronic means include a microprocessor.

5. An advertising element as defined in claim 1, further comprising control means operatable by a user and acting on said electronic means for providing information desired by a user on said display.

6. An advertising element as defined in claim 1, further comprising a memory which stores information such that the information stored preliminarily can be displayed on said display.

7. An advertising element as defined in claim 1, wherein said electronic means are formed and operate so that on said display a preliminarily stored Information and an information introduced by a user can be displayed.

8. An advertising element as defined in claim 1, further comprising an audio unit generating audio messages, and said electronic means are arranged and operatable to operate said audio unit.

9. An advertising element as defined in claim 1, further comprising a contact sensor and a movement sensor, which in response to contact or movement in a vicinity of the advertising element operate said electronic means.

10. An advertising element as defined in claim 1, wherein said body of the advertising element is springy so that it is snappable into a cavity
by compressing the advertising element, introducing into the cavity in compressed state, and then expanding to be held in the cavity by a a springy action.

11. An advertising element as defined in claim 1, further comprising control means operatable by a user and selected from the group consisting of a keyboard and a plurality of buttons.

12. An advertising element as defined in claim 11, wherein said buttons include an on/off button, an entry button, an up button, and a down button.

13. A system comprising an object, and at least one advertising element attached to the object and formed in accordance with claim 1.

14. A system as defined in claim 13, wherein said object is a product, and said advertising element is attached to said product.

15. A system as defined in claim 13, wherein said object is a product packaging, and said advertising element is attached to said product packaging.

16. A system as defined in claim 13, wherein said object includes a product and a product packaging, and wherein one advertising element formed in correspondence with claim 1 is attached to said product and another advertising element formed in correspondence with claim 1 is attached to said product packaging.
